(19) United States
(12) Patent Application Publication
(10) Pub. No.: US 2017/0132709 A1
(43) Pub. Date: May 11, 2017

(54) DATA PROCESSING METHOD, DATA PROCESSING DEVICE AND VEHICLE INSURANCE SYSTEM

(71) Applicant: Leauto Intelligent Technology (BEIJING) Co. Ltd., Beijing (CN)

(72) Inventors: Peng Liu, Beijing (CN); Kunsheng Chen, Beijing (CN); Wei Lin, Beijing (CN); Dan Li, Beijing (CN); Yong Xu, Beijing (CN); Yu Zou, Beijing (CN); Wenrui Li, Beijing (CN); Xiaofei Gou, Beijing (CN)

(73) Assignee: Leauto Intelligent Technology (BEIJING) Co. Ltd., Beijing (CN)

(21) Appl. No.: 14/979,851

(22) Filed: Dec. 28, 2015

(30) Foreign Application Priority Data
Nov. 11, 2015 (CN) 201510768295.1

(51) Int. Cl. G06Q 40/08; B60W 40/09

(52) U.S. Cl. CPC G06Q 40/08; B60W 40/09

(57) ABSTRACT

The present disclosure provides a data processing method, a data processing device and a vehicle insurance system. The method comprises acquiring acquired driving behavior data, wherein the driving behavior data at least comprises running distance, running time, running speed, running acceleration, running angular speed and running position; and transmitting the driving behavior data to electronic equipment connected with the traveling data recorder, to trigger the electronic equipment to transmit the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level. By adopting the embodiments of the present disclosure, the utilization rate of the traveling data recorder is improved, the function of the traveling data recorder is enriched.

### CROSS-REFERENCE TO RELATED APPLICATIONS

Pursuant to 35 U.S.C. §119 and the Paris Convention Treaty, this application claims the benefit of Chinese Patent Application No. 201510768295.1 filed on Nov. 11, 2015, entitled “Data Processing Method, Data Processing Device and Vehicle Insurance System”, the contents of which are incorporated herein by reference.

### FIELD OF TECHNOLOGY

The embodiments of the present disclosure relate to the technical field of vehicles, and particularly relate to a data processing method, a data processing device and a vehicle insurance system.

### BACKGROUND

A traveling data recorder is an apparatus for recording such information as images, sound and the like when a vehicle runs. After the traveling data recorder is installed in a vehicle, it can record images, sound and the like in the entire running process of the vehicle, can provide evidences for traffic accidents, and can also be used as an independent camera for shooting images and the like in a driving process.

With the popularization of the traveling data recorder, it becomes an indispensable accessory in a vehicle, whereas the present traveling data recorder merely stays at a recording aspect on acquisition of images and sound, and the images and the sound are viewed by reading a storage medium in the traveling data recorder, so the traveling data recorder is relatively single in function and low in utilization rate and increasingly cannot meet the demands of users, and the function of the traveling data recorder should be improved urgently.

### SUMMARY

One objective of the present disclosure provide a data processing method, a data processing device and a vehicle insurance system, which may solve the technical problems of single function and low utilization rate of a traveling data recorder in the prior art and enriching the function of the traveling data recorder.

To achieve the objective, in a first aspect of the embodiments of the present disclosure, a data processing method is provided, applied to a traveling data recorder, and including:

acquiring acquired driving behavior data, wherein the driving behavior data at least include running distance, running time, running speed, running acceleration, running angular speed and running position; and
transmitting the driving behavior data to electronic equipment connected with the traveling data recorder, to trigger the electronic equipment to transmit the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level.

In a second aspect of the embodiments of the present disclosure, a data processing method is provided, applied to electronic equipment, and including:

receiving driving behavior data transmitted by a traveling data recorder, wherein the driving behavior data are acquired by the traveling data recorder, and at least include running distance, running time, running speed, running acceleration, running angular speed and running position; and
transmitting the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level.

In a third aspect of the embodiments of the present disclosure, a data processing method is provided, applied to a vehicle insurance server, and including:

receiving driving behavior data transmitted by electronic equipment, wherein the driving behavior data are acquired and transmitted by a traveling data recorder connected with the electronic equipment, and at least include running distance, running time, running speed, running acceleration, running angular speed and running position;
counting the driving behavior data cumulatively received within a preset time to obtain a driving behavior habit safety level of a vehicle; and
adjusting the insurance of the vehicle according to the driving behavior habit safety level.

In a fourth aspect of the embodiments of the present disclosure, a data processing device is provided, applied to a traveling data recorder, and including:

a first acquisition unit, used for acquiring acquired driving behavior data, wherein the driving behavior data at least include running distance, running time, running speed, running acceleration, running angular speed and/or running position; and
a first transmission unit, used for transmitting the driving behavior data to electronic equipment connected with the traveling data recorder, to trigger the electronic equipment to transmit the driving behavior data to a vehicle insurance server, so that the vehicle insurance server counts the driving behavior data cumulatively received within a preset time by the vehicle insurance server to obtain a driving behavior habit safety level of a vehicle, and adjusts the insurance of the vehicle according to the driving behavior habit safety level.

In a fifth aspect of the embodiments of the present disclosure, a data processing device is provided, applied to electronic equipment, and including:

a second acquisition unit, used for receiving driving behavior data transmitted by a traveling data recorder, wherein the driving behavior data are acquired by the traveling data recorder, and at least include running distance, running time, running speed, running acceleration, running angular speed and running position; and
a second transmission unit, used for transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level.

In a sixth aspect of the embodiments of the present disclosure, a data processing device is provided, applied to a vehicle insurance server, and including:

a third acquisition unit, used for receiving driving behavior data transmitted by electronic equipment, wherein the driving behavior data are acquired and transmitted by a traveling data recorder connected with the electronic equipment, and at least include running distance, running time, running speed, running acceleration, running angular speed and running position; and
a counting unit, used for counting the driving behavior data cumulatively received within a preset time to obtain a driving behavior habit safety level of a vehicle; and
an insurance adjusting unit, used for adjusting the insurance of the vehicle according to the driving behavior habit safety level.

In a seventh aspect of the embodiments of the present disclosure, a vehicle insurance system is provided, including a vehicle insurance server, a traveling data recorder and electronic equipment;

the traveling data recorder is used for acquiring driving behavior data and transmitting the driving behavior data to the electronic equipment, and includes the data processing device provided by the fourth aspect of the embodiments of the present disclosure;
the electronic equipment is used for receiving the driving behavior data transmitted by the traveling data recorder and transmitting the driving behavior data to the vehicle insurance server, and includes the data processing device provided by the fifth aspect of the embodiments of the present disclosure; and
the vehicle insurance server is used for counting the driving behavior data cumulatively received within a preset time to obtain a driving behavior habit safety level of a vehicle and adjusting the insurance of the vehicle according to the driving behavior habit safety level, and includes the data processing device provided by the fifth aspect of the embodiments of the present disclosure.

In an eighth aspect of the embodiments of the present disclosure, a data processing device, applied to a traveling data recorder, comprises:

one or more processors; and
a storage;
one or more programs, stored in the storage and performing the following steps when being executed by the one or more processors:
acquiring acquired driving behavior data, wherein the driving behavior data at least comprise running distance, running time, running speed, running acceleration, running angular speed and/or running position; and
transmitting the driving behavior data to electronic equipment connected with the traveling data recorder, to trigger the electronic equipment to transmit the driving behavior data to a vehicle insurance server, so that the vehicle insurance server counts the driving behavior data cumulatively received within a preset time by the vehicle insurance server to obtain a driving behavior habit safety level of a vehicle, and adjusts the insurance of the vehicle according to the driving behavior habit safety level.

In a ninth aspect of the embodiments of the present disclosure, a data processing device, applied to electronic equipment, comprises:

one or more processors; and
a storage;
one or more programs, stored in the storage and performing the following steps when being executed by the one or more processors:
receiving driving behavior data transmitted by a traveling data recorder, wherein the driving behavior data are acquired by the traveling data recorder, and at least comprise running distance, running time, running speed, running acceleration, running angular speed and running position; and
transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level.

In a class of the embodiments, the device further comprises one or more programs, stored in the storage and performing the step of:

receiving and outputting safety driving prompt information comprising the driving behavior habit safety level and fed back by the vehicle insurance server.

In a tenth aspect of the embodiments of the present disclosure, a data processing device, applied to a vehicle insurance server, comprises

one or more processors; and
a storage;
one or more programs, stored in the storage and performing the following steps when being executed by the one or more processors:
receiving driving behavior data transmitted by electronic equipment, wherein the driving behavior data are acquired and transmitted by a traveling data recorder connected with the electronic equipment, and at least comprise running distance, running time, running speed, running acceleration, running angular speed and running position; and
counting the driving behavior data cumulatively received within a preset time to obtain a driving behavior habit safety level of a vehicle; and
an insurance adjusting unit, used for adjusting the insurance of the vehicle according to the driving behavior habit safety level.

In a class of embodiments of the present disclosure, the device further comprises one or more programs, stored in the storage and performing the step of:

transmitting safety driving prompt information comprising the driving behavior habit safety level to the electronic equipment, so that the electronic equipment outputs the safety driving prompt information.

According to the data processing method, the data processing device and the vehicle insurance system provided by the embodiments of the present disclosure, driving behavior data are acquired by the traveling data recorder and transmitted to the vehicle insurance server by the electronic equipment, and then the vehicle insurance server can adjust the insurance of the vehicle in combination with the driving behavior data, wherein the traveling data recorder not only can acquire video data, but also can provide the driving behavior data for the vehicle insurance system to adjust the insurance of the vehicle, so that the utilization rate of the traveling data recorder is improved, the function of the traveling data recorder is enriched, and equipment resources in the vehicle insurance system are saved.

### BRIEF DESCRIPTION OF THE DRAWINGS

In order to describe the technical solutions in the embodiments of the present disclosure or in the prior art more clearly, a simple introduction on the accompanying drawings which are needed in the description of the embodiments or the prior art is given below. Apparently, the accompanying drawings in the description below are merely some of the embodiments of the present disclosure, based on which other accompanying drawings may be obtained by those of ordinary skill in the art without any creative effort.

FIG. 1 is a flow diagram of an embodiment of a data processing method of the present disclosure;

FIG. 2 is a flow diagram of another embodiment of the data processing method of the present disclosure;

FIG. 3 is a flow diagram of a yet another embodiment of the data processing method of the present disclosure;

FIG. 4 is a flow diagram of a further embodiment of the data processing method of the present disclosure;

FIG. 5 is a flow diagram of a still further embodiment of the data processing method of the present disclosure;

FIG. 6 is a structural schematic diagram of an embodiment of a data processing device of the present disclosure;

FIG. 7 is a structural schematic diagram of another embodiment of the data processing device of the present disclosure;

FIG. 8 is a structural schematic diagram of a yet another embodiment of the data processing device of the present disclosure;

FIG. 9 is a structural schematic diagram of a further embodiment of the data processing device of the present disclosure;

FIG. 10 is a structural schematic diagram of a still further embodiment of the data processing device of the present disclosure; and

FIG. 11 is a structural schematic diagram of an embodiment of a vehicle insurance system of the present disclosure.

### DETAILED DESCRIPTION OF THE EMBODIMENTS

To make the objectives, technical solutions and advantages of the embodiments of the present disclosure clearer, a clear and complete description of the technical solutions in the present disclosure will be given below, in combination with the accompanying drawings in the embodiments of the present disclosure. Apparently, the embodiments described below are a part, but not all, of the embodiments of the present disclosure. All of other embodiments, obtained by those of ordinary skill in the art based on the embodiments of the present disclosure without any inventive efforts, fall into the protection scope of the present disclosure.

As mentioned in the background, with the popularization of the traveling data recorder, it gradually becomes an indispensable accessory in a vehicle, but the function of the traveling data recorder is single, and how to effectively utilize the traveling data recorder and increase its function to bring better driving experience to a user becomes a main development prospect thereof.

The inventor discovers in studies that, UBI (Usage Based Insurance) is gradually developed as a novel vehicle insurance pattern. The theoretical basis of UBI is to adjust the insurance in combination with driving behavior data, and a user having safe driving behavior should obtain an insurance preference theoretically. However, in the prior art, if an insurance company needs to acquire the driving behavior data, independent vehicle-mounted communication equipment needs to be installed in each vehicle to acquire the driving behavior data.

Thus, in order to improve the utilization rate of the traveling data recorder and enrich the function of the traveling data recorder, the inventor proposes the technical solutions of the present disclosure through a series of studies. In the embodiments of the present disclosure, the traveling data recorder is used as a part of a vehicle insurance system, driving behavior data are acquired by a user and transmitted to a vehicle insurance server by electronic equipment, and the vehicle insurance server can perform statistical analysis on the driving behavior data to obtain a driving behavior habit safety level and then adjust the insurance according to the driving behavior habit safety level. By adopting the embodiments of the present disclosure, the utilization rate of the traveling data recorder is improved; the traveling data recorder not only can acquire video data, but also can provide the driving behavior data for the vehicle insurance system to adjust the insurance, so the function of the traveling data recorder is enriched, equipment resources of the vehicle insurance system are saved, and the utilization rate of resources is improved.

The technical solutions of the present disclosure will be described in detail below in combination with the accompanying drawings.

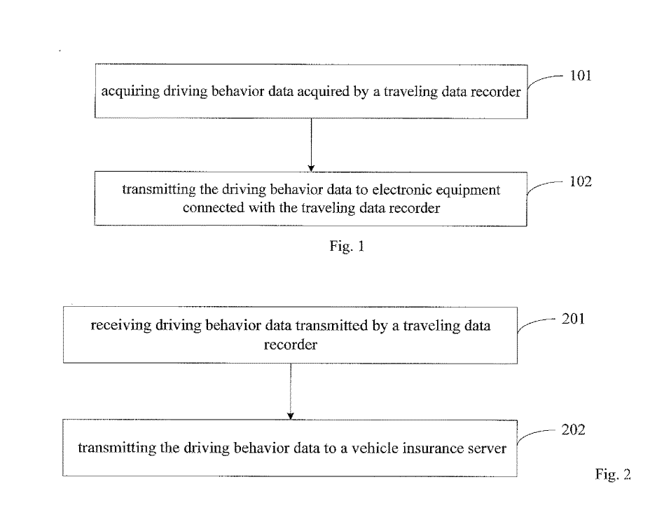

FIG. 1 is a flow diagram of an embodiment of a data processing method provided by the present disclosure. The method is specifically applied to a traveling data recorder, and may include the following several steps.

101: acquiring driving behavior data acquired by the traveling data recorder.

Wherein, the driving behavior data at least include running distance, running time, running speed, running acceleration, running angular speed and running position.

The driving behavior data may further include distance between a vehicle and a lane line and distance between the vehicle and a front vehicle.

Of course, the driving behavior data may further include other data and the like involved in the vehicle driving process.

Wherein, the distance between the vehicle and the lane line and the distance between the vehicle and the front vehicle may be obtained by recognizing video images in the video data acquired by the traveling data recorder.

The lane and the lane line where the vehicle currently runs and the front vehicle within a preset distance can be recognized by image recognition, and then the distance between the vehicle and the lane line and the distance between the vehicle and the front vehicle can be obtained.

The traveling data recorder in the embodiments of the present disclosure not only includes an image acquisition module, but also includes a motion parameter detection module, a positioning module and the like.

The image acquisition module may be a camera and other devices, for example, and is used for acquiring images and video and the like when a vehicle runs. The traveling data recorder is generally installed on a front windshield of the vehicle or around a rear reflector, so that the traveling data recorder has a relatively wide view acquisition range and thus can acquire running video data.

The motion parameter detection module may include sensors capable of detecting motion parameters, such as a speed sensor, an acceleration sensor, an angular speed sensor or a gyro and the like, so as to acquire data of running speed, running acceleration, running angular speed, running direction and the like of a vehicle.

The positioning module may be a device for positioning, such as a GPS (Global Positioning System) and the like, so as to acquire data of running track, running distance, running position and the like.

102. transmitting the driving behavior data to electronic equipment connected with the traveling data recorder, to trigger the electronic equipment to transmit the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level.

The electronic equipment may be portable mobile equipment such as a mobile phone, a tablet personal computer and the like. Because the portable mobile equipment is generally carried about by a user, when the user drives a vehicle, the carried electronic equipment can be connected with the traveling data recorder in the vehicle.

The connection between the electronic equipment and the traveling data recorder may be short-distance wireless communication connection, such as Bluetooth connection and the like. In order to improve the transmission rate, the connection between the electronic equipment and the traveling data recorder may be wifi connection, and the traveling data recorder may be used as a wifi hotspot.

The electronic equipment can transmit the driving behavior data to the vehicle insurance server, then the vehicle insurance server can adjust the insurance of the vehicle according to the driving behavior data, and the insurance can be reduced for a high driving behavior habit safety level.

Wherein, the vehicle insurance server adjusts the insurance of the vehicle according to the driving behavior habit safety level, and the insurance is UBI. UBI is a novel insurance and can be used for adjusting the insurance in combination with the driving behavior data, and a user having safer driving behavior should obtain an insurance preference theoretically.

In a possible implementation manner, for example, different driving behavior habit safety levels correspond to different insurance discount rates. The higher the driving behavior habit safety level is, the higher the discount rate is. Thus, the insurance of the vehicle is adjusted according to the driving behavior habit safety level, namely the corresponding discount rate is searched according to the driving behavior habit safety level, and the insurance is adjusted according to the discount rate, for example, if the discount rate is 80%, the adjusted insurance is original insurance*80%.

Different driving behavior habit safety levels corresponding to different insurance discount rates may be preset.

In the prior art, in order that the vehicle insurance server can acquire the driving behavior data, independent vehicle-mounted communication equipment for acquiring the driving behavior data needs to be installed in each vehicle.

In the embodiment of the present disclosure, the traveling data recorder is sufficiently utilized for acquiring the driving behavior data, the traveling data recorder can transmit the driving behavior data to the vehicle insurance server only through the electronic equipment, and then the vehicle insurance server can adjust UBI. Therefore, the function of the traveling data recorder is enriched, the utilization rate of the traveling data recorder is improved, and equipment resources of the vehicle insurance system are saved.

Wherein, as a possible implementation manner, counting the driving behavior data cumulatively received with a preset time by the vehicle insurance server to obtain a driving behavior habit safety level of a vehicle may include:

counting the driving behavior data cumulatively received within the preset time, to at least obtain an overspeed frequency when the running speed is greater than a speed threshold, a sharp acceleration frequency when the running acceleration is greater than an acceleration threshold, a sharp turning frequency when the running angular speed is greater than an angular speed threshold and a running frequency at a preset running position; and
obtaining a driving behavior habit safety level according to the overspeed frequency, the acceleration frequency, the sharp turning frequency, the running frequency at the preset running position, the running distance and the running time within the preset time.

In addition, the video data acquired by the traveling data recorder may also be transmitted to the vehicle insurance server through the electronic equipment, and the vehicle insurance server may further recognize video images of the video data received within the preset time to obtain distance between a vehicle and a lane line and distance between the vehicle and a front vehicle, and then may count to obtain a lane departure frequency when the distance between the vehicle and the lane line is smaller than a departure threshold and a collision early warning frequency when the distance between the vehicle and the front vehicle is smaller than a collision threshold.

Thus, the driving behavior habit safety level can be obtained according to the overspeed frequency, the acceleration frequency, the sharp turning frequency, the running frequency at the preset running position, the running distance and the running time within the preset time.

Different driving behavior habit safety levels express degrees of driving behavior safety; the higher the safety level is, the safer the driving behavior is; and the lower the safety level is, the more unsafe the driving behavior is.

Wherein, the relation of the overspeed frequency, the acceleration frequency, the sharp turning frequency, the running frequency at the preset running position, the running distance, the running time, the lane departure frequency, the collision early warning frequency and the like within the preset time and the driving behavior habit safety level can be preset and expressed through an expression. For example,

it is supposed that the driving behavior habit includes five types of data expressed by a, b, c, d and e, the weight of each type of data is different, and the weight expresses the influence degree of this type of data on a safety coefficient;
the driving behavior habit safety level can be expressed by the following expression: ax+by+cz+dw+eu=M, wherein x, y, z, w and u respectively express a weight coefficient, the specific values of a, b, c, d and e in the driving behavior habit are substituted into the expression, and the driving behavior habit safety level can be obtained.

It should be noted that, only a manner of calculating the driving behavior habit safety level is schematically described above, of course, other manners may also be adopted, or UBI insurance adjustment in the prior art is adopted for processing the driving behavior data.

FIG. 2 is a flow diagram of another embodiment of the data processing method provided by the present disclosure. The method is specifically applied to electronic equipment, and may include the following steps:

201: receiving driving behavior data transmitted by a traveling data recorder.

Wherein, the driving behavior data are acquired by the traveling data recorder, and at least include running distance, running time, running speed, running acceleration, running angular speed and running position;

202: transmitting the driving behavior data to a vehicle insurance server, so that counting the driving behavior data cumulatively received within a preset time by the vehicle insurance server to obtain a driving behavior habit safety level of a vehicle, and adjusting the insurance of the vehicle according to the driving behavior habit safety level.

Wherein, the electronic equipment may further receive video images of video data acquired by the traveling data recorder for recognizing to obtain distance between a vehicle and a lane line and distance between the vehicle and a front vehicle, and send the processing result to the vehicle insurance server.

The vehicle insurance server counts the driving behavior data cumulatively received within the preset time as well as the distance between the vehicle and the lane line and the distance between the vehicle and the front vehicle to obtain a driving behavior habit safety level of the vehicle, and then adjusts the insurance of the vehicle according to the driving behavior habit safety level.

Wherein, counting the driving behavior data cumulatively received within a preset time by the vehicle insurance server to obtain a driving behavior habit safety level of a vehicle may be:

counting the driving behavior data cumulatively received within the preset time, to at least obtain an overspeed frequency when the running speed is greater than a speed threshold, a sharp acceleration frequency when the running acceleration is greater than an acceleration threshold, a sharp turning frequency when the running angular speed is greater than an angular speed threshold and a running frequency at a preset running position; and
obtaining a driving behavior habit safety level according to the overspeed frequency, the acceleration frequency, the sharp turning frequency, the running frequency at the preset running position, the running distance and the running time within the preset time.

In the embodiment of the present disclosure, the traveling data recorder is sufficiently utilized for acquiring the driving behavior data and sending the driving behavior data to the electronic equipment, the electronic equipment transmits the driving behavior data to the vehicle insurance server, and the vehicle insurance server can adjust UBI. Therefore, the function of the traveling data recorder is enriched, the utilization rate of the traveling data recorder is improved, and equipment resources of the vehicle insurance system are saved.

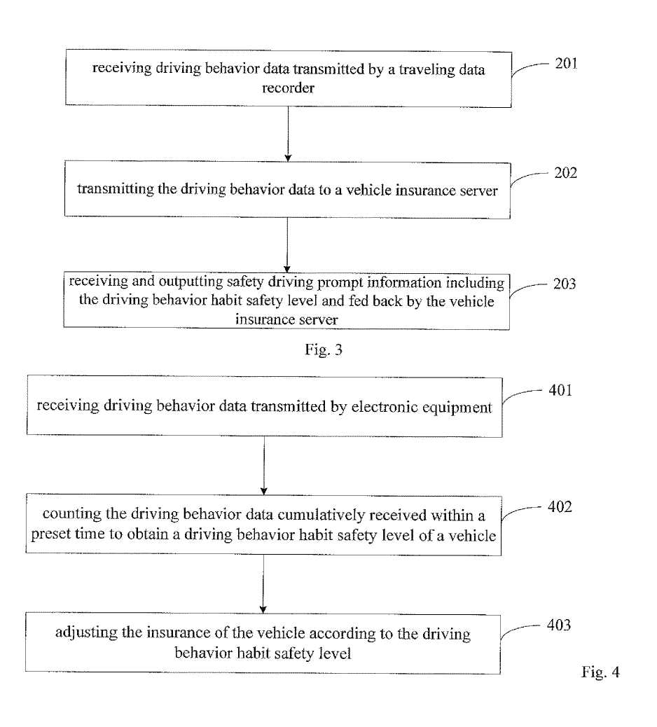

As a further embodiment, as shown in FIG. 3, after transmitting the driving behavior data to the vehicle insurance server in step 202, the method may further include:

203: receiving and outputting safety driving prompt information including the driving behavior habit safety level and fed back by the vehicle insurance server.

The safety driving prompt information may be used for prompting the user whether the driving behavior is safe and how to correct the current driving behavior, so as to improve the driving safety, obtain preferential insurance and the like.

As a further embodiment, after the electronic equipment receives the driving behavior data transmitted by the traveling data recorder, the method may further include: counting the driving behavior data cumulatively received within a preset time to obtain a driving behavior habit safety level of a vehicle, determining an insurance adjustment value according to the driving behavior habit safety level, and outputting the insurance adjustment value for user reference, so that a user can optimize own driving behavior according to the insurance adjustment value to obtain more preferential insurance.

FIG. 4 is a flow diagram of a further embodiment of the data processing method provided by the present disclosure. The method is applied to a vehicle insurance server, and may include the following steps:

401: receiving driving behavior data transmitted by electronic equipment, wherein the driving behavior data are acquired and transmitted by a traveling data recorder connected with the electronic equipment, and at least include running distance, running time, running speed, running acceleration, running angular speed and running position;
402: counting the driving behavior data cumulatively received within a preset time to obtain a driving behavior habit safety level of a vehicle; and
403: adjusting the insurance of the vehicle according to the driving behavior habit safety level.

Wherein, for obtaining the driving behavior habit safety level and adjusting the insurance, reference may be made to the above embodiments, which are not repeated herein.

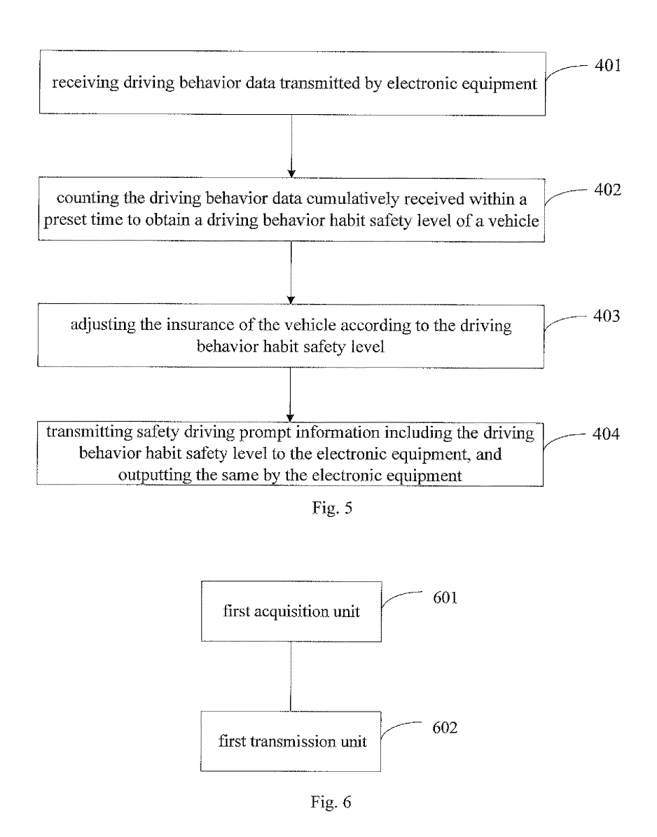

In the embodiment of the present disclosure, the traveling data recorder is sufficiently utilized for acquiring the driving behavior data and sending the driving behavior data to the electronic equipment, the electronic equipment transmits the driving behavior data to the vehicle insurance server, and the vehicle insurance server can adjust UBI. Therefore, the function of the traveling data recorder is enriched, the utilization rate of the traveling data recorder is improved, and equipment resources of the vehicle insurance system are saved.

Wherein, as shown in FIG. 5, after counting the driving behavior data cumulatively received within the preset time to obtain the driving behavior habit safety level of the vehicle in step 402, the method further includes:

404: transmitting safety driving prompt information including the driving behavior habit safety level to the electronic equipment, and outputting the same by the electronic equipment.

Wherein, the safety driving prompt information may further include a driving behavior habit, namely overspeed frequency, acceleration frequency, sharp turning frequency, running frequency at a preset running position, running distance, running time and the like within a preset time.

The safety driving prompt information may further include a safety driving advice generated according to the driving behavior habit safety level, so that a user can correct own driving behavior according to the safety driving advice.

Moreover, because the vehicle insurance server can obtain driving behavior data acquired by traveling data recorders connected with different electronic equipment and transmitted by the electronic equipment, the driving behavior data acquired by the traveling data recorder connected with each piece of electronic equipment and transmitted by the electronic equipment can be counted to obtain a driving behavior habit safety level.

Thus, the application server may further compare the driving behavior habit safety level with that obtained according to the driving behavior data transmitted by any electronic equipment associated with the electronic equipment to obtain a comparison result.

The comparison result may include a safety level rank and/or vehicles superior to the driving behavior habit safety level, the number of the vehicles, etc.

The comparison result may also be included in the safety driving prompt information, so that a user can better learn own driving behavior and then correct unsafe driving behavior.

FIG. 6 is a structural schematic diagram of an embodiment of a data processing device provided by the present disclosure. The device is specifically applied to a traveling data recorder, and may be integrated into a processor or a microcontroller in the traveling data recorder. The traveling data recorder may further include an image acquisition module, a motion parameter detection unit, a positioning module and the like which are connected with the device.

The image acquisition module may be a camera and the like, for example, and is used for acquiring images and video and the like when a vehicle runs. The traveling data recorder is generally installed on a front windshield of a vehicle or around a rear reflector, so that the traveling data recorder has a relatively wide view acquisition range and can acquire running video data.

The motion parameter detection module may include sensors capable of detecting motion parameters, such as a speed sensor, an acceleration sensor, an angular speed sensor or a gyro and the like, so as to acquire data of running speed, running acceleration, running angular speed, running direction and the like of a vehicle.

The positioning module may be a device for positioning, such as a GPS (Global Positioning System), so as to acquire data of running track, running distance, running position and the like.

The device may include:

a first acquisition unit 601, used for acquiring acquired driving behavior data, wherein the driving behavior data at least include running distance, running time, running speed, running acceleration, running angular speed and/or running position; and
a first transmission unit 602, used for transmitting the driving behavior data to electronic equipment connected with the traveling data recorder, to trigger the electronic equipment to transmit the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level.

In the embodiment of the present disclosure, the traveling data recorder is sufficiently utilized for acquiring the driving behavior data, the traveling data recorder can transmit the driving behavior data to the vehicle insurance server only through the electronic equipment, and the vehicle insurance server can adjust UBI. Therefore, the function of the traveling data recorder is enriched, the utilization rate of the traveling data recorder is improved, and equipment resources of the vehicle insurance system are saved.

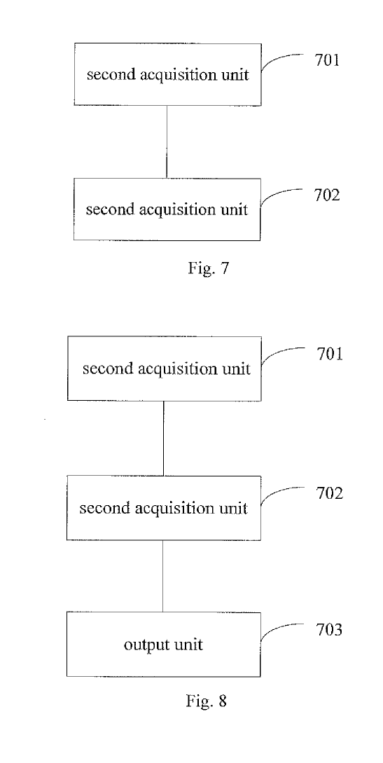

FIG. 7 is a structural schematic diagram of another embodiment of the data processing device provided by the present disclosure. The device is specifically applied to electronic equipment, can be integrated to a processor of the electronic equipment, and can also be connected with the processor of the electronic equipment as an independent module.

The electronic equipment may be portable mobile equipment such as a mobile phone, a tablet personal computer and the like. Because the portable mobile equipment is generally carried by a user, when the user drives a vehicle, the carried electronic equipment can be connected with the traveling data recorder in the vehicle.

The connection between the electronic equipment and the traveling data recorder may be short-distance wireless communication connection, such as Bluetooth connection and the like. In order to improve the transmission rate, the connection between the electronic equipment and the traveling data recorder may be wifi connection, and the traveling data recorder may be used as a wifi hotspot.

The device may include:

a second acquisition unit 701, used for receiving driving behavior data transmitted by a traveling data recorder, wherein the driving behavior data are acquired by the traveling data recorder, and at least include running distance, running time, running speed, running acceleration, running angular speed and running position; and
a second transmission unit 702, used for transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level.

Wherein, the electronic equipment may further receive video images of video data acquired by the traveling data recorder for recognizing to obtain distance between a vehicle and a lane line and distance between the vehicle and a front vehicle, and send the processing result to the vehicle insurance server.

The vehicle insurance server counts the driving behavior data cumulatively received within the preset time as well as the distance between the vehicle and the lane line and the distance between the vehicle and the front vehicle to obtain a driving behavior habit safety level of the vehicle, and then adjusts the insurance of the vehicle according to the driving behavior habit safety level.

In the embodiment of the present disclosure, the traveling data recorder is sufficiently utilized for acquiring the driving behavior data and sending the driving behavior data to the electronic equipment, the electronic equipment transmits the driving behavior data to the vehicle insurance server, and the vehicle insurance server can adjust UBI. Therefore, the function of the traveling data recorder is enriched, the utilization rate of the traveling data recorder is improved, and equipment resources of the vehicle insurance system are saved.

As a yet another embodiment, as shown in FIG. 8, the device may further include: an output unit 703, used for receiving and outputting safety driving prompt information including the driving behavior habit safety level and fed back by the vehicle insurance server.

The safety driving prompt information may be used for prompting the user whether the driving behavior is safe and how to correct the current driving behavior, so as to improve the driving safety, obtain preferential insurance and the like.

FIG. 9 is a structural schematic diagram of a further embodiment of the data processing device provided by the present disclosure. The device is specifically applied to a vehicle insurance server. The device may include:

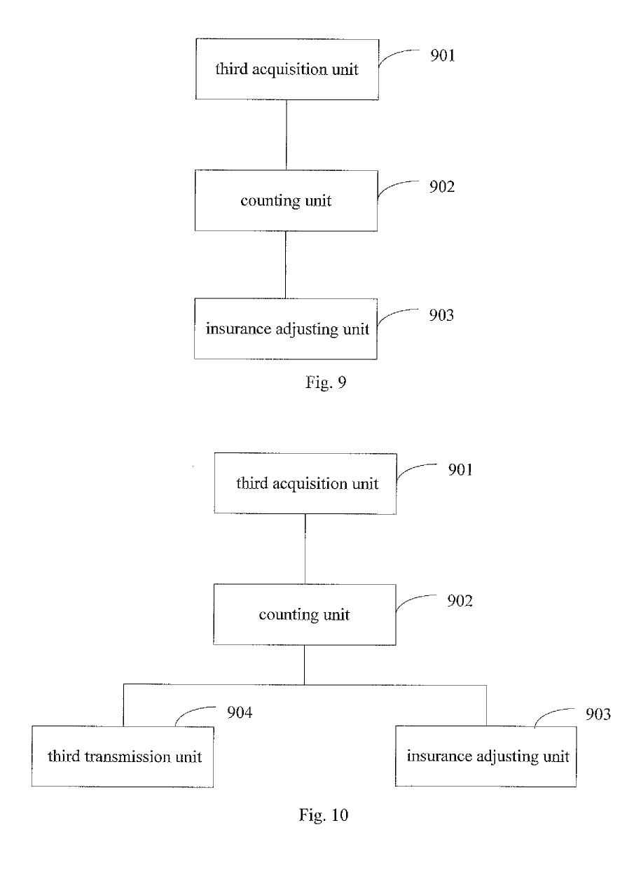

a third acquisition unit 901, used for receiving driving behavior data transmitted by electronic equipment, wherein the driving behavior data are acquired and transmitted by a traveling data recorder connected with the electronic equipment, and at least include running distance, running time, running speed, running acceleration, running angular speed and running position; and
a counting unit 902, used for counting the driving behavior data cumulatively received within a preset time to obtain a driving behavior habit safety level of a vehicle; and
an insurance adjusting unit 903, used for adjusting the insurance of the vehicle according to the driving behavior habit safety level.

Wherein, according to a still further embodiment, as shown in FIG. 10, the device may further include:

a third transmission unit 904, used for transmitting safety driving prompt information including the driving behavior habit safety level to the electronic equipment, so that the electronic equipment outputs the safety driving prompt information.

Wherein, the counting unit 902 used for counting the driving behavior data cumulatively received within a preset time to obtain a driving behavior habit safety level of a vehicle may specifically be used for:

counting the driving behavior data cumulatively received within the preset time, to at least obtain an overspeed frequency when the running speed is greater than a speed threshold, a sharp acceleration frequency when the running acceleration is greater than an acceleration threshold, a sharp turning frequency when the running angular speed is greater than an angular speed threshold and a running frequency at a preset running position; and
obtaining a driving behavior habit safety level according to the overspeed frequency, the acceleration frequency, the sharp turning frequency, the running frequency at the preset running position, the running distance and the running time within the preset time.

In addition, the video data acquired by the traveling data recorder may also be transmitted to the vehicle insurance server through the electronic equipment, and the vehicle insurance server may further recognize video images of the video data received within the preset time to obtain distance between a vehicle and a lane line and distance between the vehicle and a front vehicle, and then may count a lane departure frequency when the distance between the vehicle and the lane line is smaller than a departure threshold and a collision early warning frequency when the distance between the vehicle and the front vehicle is smaller than a collision threshold.

Thus, the driving behavior habit safety level can be obtained according to the overspeed frequency, the acceleration frequency, the sharp turning frequency, the running frequency at the preset running position, the running distance and the running time within the preset time.

Different driving behavior habit safety levels express degrees of driving behavior safety; the higher the safety level is, the safer the driving behavior is; and the lower the safety level is, the more unsafe the driving behavior is.

Wherein, the relation of the overspeed frequency, the acceleration frequency, the sharp turning frequency, the running frequency at the preset running position, the running distance, the running time, the lane departure frequency, the collision early warning frequency and the like within the preset time and the driving behavior habit safety level can be preset and expressed through an expression.

In the embodiment of the present disclosure, the traveling data recorder is sufficiently utilized for acquiring the driving behavior data and sending the driving behavior data to the electronic equipment, the electronic equipment transmits the driving behavior data to the vehicle insurance server, the vehicle insurance server can adjust UBI and transmit the safety driving prompt information such as the driving behavior habit safety level and the like to the electronic equipment, and the electronic equipment outputs the safety driving prompt information, so that a user can learn own driving behavior to correct an unsafe driving behavior, the driving safety can be improved, and preferential insurance can be obtained. By adopting the embodiment of the present disclosure, the function of the traveling data recorder is enriched, the utilization rate of the traveling data recorder is improved, equipment resources of the vehicle insurance system are saved and the user driving experience is improved.

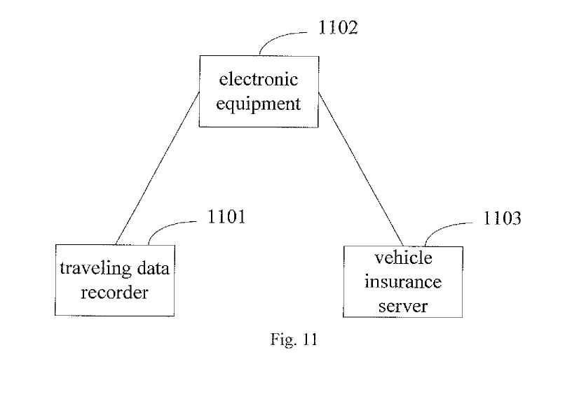

In addition, the present disclosure further provides a vehicle insurance system. As mentioned in FIG. 11, the vehicle insurance system includes a traveling data recorder 1101, electronic equipment 1102 and a vehicle insurance server 1103.

Wherein, the traveling data recorder 1101 may include the data processing device described by the embodiment of FIG. 6; the electronic equipment 1102 may include the data processing device described by the embodiment of FIG. 7 or FIG. 8; and the vehicle insurance server 1103 may include the data processing device described by the embodiment of FIG. 9 or FIG. 10.

The traveling data recorder 1101 is used for acquiring driving behavior data and transmitting the driving behavior data to the electronic equipment;

the electronic equipment 1102 is used for receiving the driving behavior data transmitted by the traveling data recorder and transmitting the driving behavior data to the vehicle insurance server; and
the vehicle insurance server 1103 is used for counting the driving behavior data cumulatively received within a preset time to obtain a driving behavior habit safety level of a vehicle and adjusting the insurance of the vehicle according to the driving behavior habit safety level.

Wherein, the vehicle insurance server may further transmit safety driving prompt information including the driving behavior habit safety level to the electronic equipment, so that the electronic equipment outputs the safety driving prompt information.

According to the vehicle insurance system of the embodiment of the present disclosure, the traveling data recorder is sufficiently utilized for acquiring the driving behavior data so dedicated vehicle-mounted communication equipment is not needed, equipment resources are saved, the utilization rate of the traveling data recorder is improved, and the function of the traveling data recorder is enriched.

The device embodiments described above are merely schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the units according to actual needs. Those of ordinary skill in the art could understand and implement the embodiments without any creative effort.

Through the descriptions of the above embodiments, those skilled in the art could clearly learn that each implementation manner may be realized by means of software and a necessary general hardware platform, and of course, may be realized by hardware. Based on such an understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling one piece of computer equipment (which may be a personal computer, a server, or network equipment and the like) to execute each embodiment or the method at some part of each embodiment.

Finally, it should be noted that, the above embodiments are merely used for illustrating the technical solutions of the present disclosure, rather than limiting the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of technical characteristics thereof; and these modifications or substitutions do not make the nature of the corresponding technical solutions depart from the spirit and scope of the technical solutions of the respective embodiments of the present disclosure.

What is claimed is:

1. A data processing method, applied to a traveling data recorder, and comprising:
acquiring acquired driving behavior data, wherein the driving behavior data at least comprise running distance, running time, running speed, running acceleration, running angular speed and running position; and
transmitting the driving behavior data to electronic equipment connected with the traveling data recorder, to trigger the electronic equipment to transmit the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level.

2. A data processing method, applied to an electronic equipment, and comprising:
receiving driving behavior data transmitted by a traveling data recorder, wherein the driving behavior data are acquired by the traveling data recorder, and at least comprise running distance, running time, running speed, running acceleration, running angular speed and running position; and
transmitting the driving behavior data to a vehicle insurance server, counting the driving behavior data cumulatively received within a preset time by the vehicle insurance server to obtain a driving behavior habit safety level of a vehicle, and adjusting the insurance of the vehicle according to the driving behavior habit safety level.

3. The method of claim 2, wherein after transmitting the driving behavior data to a vehicle insurance server, the method further comprises:
receiving and outputting safety driving prompt information comprising the driving behavior habit safety level and fed back by the vehicle insurance server.

4. A data processing method, applied to a vehicle insurance server, and comprising:
receiving driving behavior data transmitted by electronic equipment, wherein the driving behavior data are acquired and transmitted by a traveling data recorder connected with the electronic equipment, and at least comprise running distance, running time, running speed, running acceleration, running angular speed and running position;
counting the driving behavior data cumulatively received within a preset time to obtain a driving behavior habit safety level of a vehicle; and
adjusting the insurance of the vehicle according to the driving behavior habit safety level.

5. The method of claim 4, wherein after counting the driving behavior data cumulatively received within a preset time to obtain a driving behavior habit safety level of a vehicle, the method further comprises:
transmitting safety driving prompt information comprising the driving behavior habit safety level to the electronic equipment, and outputting the same by the electronic equipment.

6. A data processing device, applied to a traveling data recorder, and comprising:
one or more processors; and
a storage;
one or more programs, stored in the storage and performing the following steps when being executed by the one or more processors:
acquiring acquired driving behavior data, wherein the driving behavior data at least comprise running distance, running time, running speed, running acceleration, running angular speed and/or running position; and
transmitting the driving behavior data to electronic equipment connected with the traveling data recorder, to trigger the electronic equipment to transmit the driving behavior data to a vehicle insurance server, so that the vehicle insurance server counts the driving behavior data cumulatively received within a preset time by the vehicle insurance server to obtain a driving behavior habit safety level of a vehicle, and adjusts the insurance of the vehicle according to the driving behavior habit safety level.

7. A data processing device, applied to electronic equipment, and comprising:
one or more processors; and
a storage;
one or more programs, stored in the storage and performing the following steps when being executed by the one or more processors:
receiving driving behavior data transmitted by a traveling data recorder, wherein the driving behavior data are acquired by the traveling data recorder, and at least comprise running distance, running time, running speed, running acceleration, running angular speed and running position; and
transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level.

8. The data processing device of claim 7, further comprising one or more programs, stored in the storage and performing the step of:
receiving and outputting safety driving prompt information comprising the driving behavior habit safety level and fed back by the vehicle insurance server.

9. A data processing device, applied to a vehicle insurance server, and comprising
one or more processors; and
a storage;
one or more programs, stored in the storage and performing the following steps when being executed by the one or more processors:
receiving driving behavior data transmitted by electronic equipment, wherein the driving behavior data are acquired and transmitted by a traveling data recorder connected with the electronic equipment, and at least comprise running distance, running time, running speed, running acceleration, running angular speed and running position; and
counting the driving behavior data cumulatively received within a preset time to obtain a driving behavior habit safety level of a vehicle; and
adjusting the insurance of the vehicle according to the driving behavior habit safety level.

10. The data processing device of claim 9, further comprising one or more programs, stored in the storage and performing the step of:
transmitting safety driving prompt information comprising the driving behavior habit safety level to the electronic equipment, so that the electronic equipment outputs the safety driving prompt information.

11. A vehicle insurance system, comprising a vehicle insurance server, a traveling data recorder and electronic equipment, wherein
the traveling data recorder is used for acquiring driving behavior data and transmitting the driving behavior data to the electronic equipment, and comprises a data processing device, comprising:
one or more processors; and
a storage;
one or more programs, stored in the storage and performing the following steps when being executed by the one or more processors:
receiving driving behavior data transmitted by a traveling data recorder, wherein the driving behavior data are acquired by the traveling data recorder, and at least comprise running distance, running time, running speed, running acceleration, running angular speed and running position; and
transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level;
the electronic equipment is used for receiving the driving behavior data transmitted by the traveling data recorder and transmitting the driving behavior data to the vehicle insurance server, and comprises a data processing device, comprising:
one or more processors; and
a storage;
one or more programs, stored in the storage and performing the following steps when being executed by the one or more processors:
receiving driving behavior data transmitted by a traveling data recorder, wherein the driving behavior data are acquired by the traveling data recorder, and at least comprise running distance, running time, running speed, running acceleration, running angular speed and running position; and
transmitting the driving behavior data to a vehicle insurance server, so that the vehicle insurance server counts the driving behavior data cumulatively received within a preset time to obtain a driving behavior habit safety level of a vehicle, and adjusts the insurance of the vehicle according to the driving behavior habit safety level; and
the vehicle insurance server is used for counting the driving behavior data cumulatively received within a preset time to obtain a driving behavior habit safety level of a vehicle and adjusting the insurance of the vehicle according to the driving behavior habit safety level, and comprises the data processing device, comprising:
one or more processors; and
a storage;
one or more programs, stored in the storage and performing the following steps when being executed by the one or more processors:
receiving driving behavior data transmitted by electronic equipment, wherein the driving behavior data are acquired and transmitted by a traveling data recorder connected with the electronic equipment, and at least comprise running distance, running time, running speed, running acceleration, running angular speed and running position; and
counting the driving behavior data cumulatively received within a preset time to obtain a driving behavior habit safety level of a vehicle; and
adjusting the insurance of the vehicle according to the driving behavior habit safety level.
